(19) United States
(12) Patent Application Publication
(10) Pub. No.: US 2010/0277428 A1
(43) Pub. Date: Nov. 4, 2010

(54) TOUCH PANEL INPUT ASSISTING DEVICE, COMPUTER OPERATING METHOD USING THE DEVICE, AND TACTILE SENSE INTERLOCKING PROGRAM

(76) Inventor: Itsuo Kumazawa, Kanagawa (JP)

Correspondence Address: Yasuo Muramatsu;MURAMATSU & ASSOCIATES, 114 pacifica, suite 310, Irvine, CA, 92618, US

(21) Appl. No.: 12/733,417

(22) PCT Filed: Aug. 29, 2007
(86) PCT No.: PCT/JP2008/065603

§ 371 Date: Jul. 1, 2010

(51) Int. Cl. G06F 3/041

(52) U.S. Cl. 345/173; 345/179

(57) ABSTRACT

[PROBLEMS] To detect any of various movements of a finger by using the touch panel of an existing device and to give tactile sense to facilitate operation.

[MEANS FOR SOLVING PROBLEMS] A touch panel input assisting device attached to an existing device having a touch panel or held by fingers so as to use it. Any of various movements of a finger is transformed into rolling of a rolling unit on a touch panel or deformation thereof, the rolling or deformation is detected as a variation of the position or area of the contact of the rolling unit with the touch panel, and a tactile sense such as a reactive force, a resistance force, vibration, or a sensation of roughness is given to the finger. A tactile interlocking program for analyzing the movement pattern and speed pattern of the point of contact of the rolling unit with the touch panel and estimating the movement of the finger is used to perform a predetermined operation interlockingly with the movement of the finger or tactile sense given to the finger.

### TECHNICAL FIELD

The present invention relates to a touch panel input assisting device that converts various finger movements into contact patterns by a rolling motion of a rolling unit on a touch panel while giving reaction force, such as a resistance force or repulsive force to the finger; and a computer operating method to detect the timing of the original finger movements or the reaction force being exerted to the finger based on the change patterns of the position or speed of a contact point of the rolling unit on the touch panel and to execute a computer by synchronizing the timing with the computer and a tactile sense interlocking program.

### BACKGROUND ART

Conventionally, a finger or a pen-like-instrument called a stylus has been used to contact the touch-panel surface, and to input coordinates of the contact point. However, in either case, tactile feedback has been insufficient and, as a result, visual or auditory sense has been needed to confirm whether the input was performed correctly.

In order to cope with this problem and enable it to confirm the result or content of the input, such as the contact position etc. not only through vision or hearing but through a tactile sense, this invention provides an apparatus that lies between the finger and touch panel to assist the touch panel operation and a method or a program that uses the apparatuses effectively in aiming for improvement of the usability of the user interface or the reality of the game operation. Although various kinds of tactile feedback devices have been developed, the trial of solving the above-mentioned problem through a device which is interposed between a touch panel and a finger does not exist, and that is the point of the novelty of this invention.

The patent documents relevant to this invention are shown below.

Patent Document 1: Japanese Unexamined Patent Application Publication No. 9-128149

Patent Document 1: Japanese Unexamined Patent Application Publication No. 2001-306238

The method of inputting data and instructions by the operation of rolling a roller-like unit on a touch panel is shown in patent documents 1 and 2. However, any technique uses the rolling unit only as a means for inputting information, and does not use it as a means for adding tactile feedback, and the device for it was not given.

### DISCLOSURE OF INVENTION

This invention uses a rolling unit as a means to apply a feeling of not only unevenness but reaction force to a finger. And by making a program synchronize with such a tactile feedback, operation of the program can be confirmed through the tactile sense, and the usability of a user interface and the presence of a game are improved. Moreover, in this invention, a touch panel input assisting device is applied to the touch panel, which functions alone (independently) and can be operated also by the finger or a stylus, by equipping the touch panel with the apparatus separately, by equipping the finger with the apparatus or by holding the apparatus with the finger. Therefore, the means to equip the touch panel with the apparatus so that the attachment and detachment are possible, or the holding or the wearing means for the finger to be equipped with the apparatus is established in this invention. Thus, it became possible to exclude the sensing function by the side of the touch-panel-input-assisting-device, and to reduce the device cost sharply by detecting movement of a finger utilizing the sensing function (i.e. contact position detection mechanism) of the existing touch panel. Moreover, the structure for equipping a finger with the touch-panel-input-assisting-device is established in one of embodiments of this invention. Such a concept of having equipped a finger with the touch-panel-input-assisting-device and operating a touch panel with it is new and does not exist previously. Although there may be some structure which can be interpreted also as a type of rolling unit, rolling on the position detecting sensor in the conventional joy stick, as it contains sensing function equipment in itself, its structure becomes complicated and the cost also becomes high, unlike this invention.

This invention was made in view of the above situation and uses a special instrument interposed between a finger and a touch panel in which the tactile feedback lacks for its operation, and thereby it gives a tactile feeling of the reaction force or the uneven surface to the finger under the operation and, by controlling a program to synchronize with these tactile feeling, it improves the usability of a user interface and the presence of a game and offers the touch-panel-input-assisting-device, which can be produced at a low cost by utilizing the sensing function of a touch panel, a computer operating method using the device, and a program synchronized with the tactile feeling. A means for giving reaction force to a finger is hereafter called a “reaction-force-generation-means”.

In order to achieve the above-mentioned object, an element called a rolling unit is interposed between a finger and a touch panel in this invention. And by using it, various finger movements are converted into the rolling movements of the rolling unit on a touch panel, and then the contact position of the rolling unit on the touch panel and its change (that is, consequently the contact patterns generated by the rolling movements) are detected using the contact position detecting function of the touch panel, and thereby the original finger movements and the reaction force applied to the finger during the finger movements are detected. Moreover, the reaction force such as a resistance force or a repulsive force makes it possible for the operator to confirm the appropriateness of the finger movement tactually, and thus the operator can adjust the quantity of motion or the degree of force by using the tactile feedback and input analog information with sufficient accuracy. A means to convert the various finger movements into the various contact patterns, which a touch panel can detect, will be hereafter called a contact-pattern-generation-means. The contact pattern means the contact form, such as a position or an area size where the touch-panel-input-assisting-device contacts a touch panel, or the form of their change with regard to time. Although a pattern has the meaning “model” besides the meaning “form”, this invention uses it in the sense of the latter.

Conventional touch panels only detect the contact to a touch panel, the separation from the touch panel, and the movement of a finger or a stylus to a direction parallel to the panel surface. However, according to this invention, the finger movement perpendicular or slanted to the touch panel surface is detectable by converting the finger movement into the movement of a rolling unit on the touch panel. Moreover, movement of the finger for rotating a sphere-like-object such as a trackball, or a dial is detectable by converting it into the movement of a rolling unit on the touch panel. Moreover, since the contact point of a rolling unit and a touch panel will move by a characteristic pattern specific to each finger movement pattern, the original finger movement pattern can be estimated by analyzing the pattern by a program. In addition, the conventional input operation using a finger or a stylus on the touch panel were not able to make the operator feel the tactile feedback such as a resistance force, reaction force, a feeling of unevenness, or vibration. However, using a rolling unit makes it possible to give such tactile feedback.

According to this invention, upon using a device equipped with an existing touch panel, an operator can use the separate and low-cost touch-panel-input-assisting-device, which is attached to the device or a finger or held with a finger, and thereby the operator can feel the tactile feeling, which his finger would feel when operating other familiar devices, and input information correctly and intelligibly. In addition, by using the tactile sense interlocking program which estimates the movement of the finger from the movement pattern of the contact position of a rolling unit and a touch panel, the device operation can be synchronized with the finger movement and the tactile feeling and it becomes possible to have presence while operating the device.

### BEST MODE FOR CARRYING OUT THE INVENTION

FIG. 1 is a functional block diagram of a computer system 89 which uses a touch-panel-input-assisting-device 80 as a data input device. The computer system 89 includes an input device 85 which inputs data, a data-processing device 87 which performs the data processing of a program using the inputted data, an output device 86 which outputs the result of the processing, and a storage device 88 which stores data. Moreover, the input device 85 includes a touch panel 2 which consists of a panel 81 and a contact-position-detection-means 82, and the touch-panel-input-assisting-device 80 which inputs data to the device 80 through this touch panel 2. The computer system 89 can be a general-purpose personal computer or may be a game machine or a music player for exclusive use. The touch-panel-input-assisting-device 80 of this invention is used in combination with the panel 81 equipped with the contact-position-detection-means 82 prepared separately from it as shown in FIG. 1. Hereafter, the panel equipped with the contact-position-detection-means will be called the touch panel 2. This touch panel 2 is given by the existing equipment, separate from the touch-panel-input-assisting-device of this invention. Moreover, a tactile sense interlocking program of this invention is stored in the storage device 88 of FIG. 1 and executed by a data-processing device 87. The tactile sense interlocking program detects the movement of a finger which operates the touch-panel-input-assisting-device 80, based on the information given by the contact-position-detection-means 82 about the contact position and, if necessary, the size of contact area of the touch panel and the touch-panel-input-assisting-device 80.

The tactile sense interlocking program is stored in the storage device 88, loaded to the data-processing device 87, and is executed. For example, the movement or speed pattern of the contact position of a rolling unit and a touch panel is compared with the patterns registered in advance, and a predetermined operation which is related to the matched pattern is executed. More simply, when a rolling unit separates from the touch panel, the operation associated with the amount or the speed of movement of the contact point is executed. The time when the operation is executed can be the time when the moving direction of the contact point is being reversed, or when a predetermined position, distance or speed is reached. In this case, since the contact position and its speed generated by the contact-pattern-generation-means are restricted to the range between the lower and upper limits which are characterized by the touch-panel-input-assisting-device, it is necessary to define the mapping relation between the pattern and the operation in consideration of the characteristic of the touch-panel-input-assisting-device 80, so that the operation needed can be executed within the value of the restricted range.

### (The Operation Method of Mapping Relation)

The contact pattern which the contact-pattern-generation-means of the touch-panel-input-assisting-device 80 generates is detected by the contact-position-detection-means 82 of a touch panel, for example as a time series signal of the amount of change ΔX, movement speed V, moving direction θ of a contact position. When the finger holding the touch-panel-input-assisting-device 80 performs a predetermined action, the actual values which this time series signal takes depends on the characteristic of the touch-panel-input-assisting-device 80 and a touch panel. For example, the signal ΔX, which the contact-pattern-generation-means generates when the touch-panel-input-assisting-device is operated so that the reaction-force-generation-means of the touch-panel-input-assisting-device 80 may apply a properly strong reaction force to a finger, might be too small and the amount of operation might be insufficient when the small signal value is used as it is for the amount of operation of the program. In that case, scale adjustment by multiplying the constant α is needed so that the value of the proper range may be obtained by the following formula to define the amount of operations of the program, for example, where ΔZ is the amount of movement of a character in a video game. ΔZ=α·ΔX (formula 1 which defines the mapping relation of a contact pattern and the amount of operation of the program).

Moreover, as for the moving direction 8 of the contact point, the reference direction S needs to be determined according to the characteristic of the touch-panel-input-assisting-device 80 and the touch panel 2. In order to take a proper and intuitive correspondence between the direction of the finger movement or the direction of the reaction force and the direction O of a character movement, it is necessary to define the mapping relation between them by the following formula for example. O=θ−S (formula 2 which defines the mapping relation of a contact pattern and the amount of operation of the program).

When the touch-panel-input-assisting-device 80 separates from the touch panel 81 after contacting the touch panel 81, the reaction-force-generation-means applies reaction force of a proper strength to a finger. The timing of the separation or the force application is detected by the program, checking if each of ΔX and the average Vm of the past time series of the speed V exceeds a threshold predetermined respectively and the direction of speed is reversed. In this case, the mapping relation between a variable F, which defines the operation of program, and ΔX, V, Vm, and θ of a contact pattern is defined in the following procedure of the program.
IF ΔX>β AND Vm>γ AND θ=180 degrees THEN F=TRUE ELSE F=FALSE (procedure which defines the mapping relation between the contact pattern and the operation of the program).
In order for the touch-panel-input-assisting-device 80 to give suitable tactile feeling for a finger and in order to give a suitable margin to avoid malfunction, the threshold values of β or γ should be adjusted according to the characteristic of the touch-panel-input-assisting-device 80 and the touch panel 2.

Furthermore, the contact pattern (ΔX, V, θ) and its time series signal [(ΔX(1), V(1), θ(1)), (ΔX(2), V(2), θ(2)), . . . ] for a predetermined finger movement with a predetermined tactile feeling are paired with the corresponding operation of the program and registered in a table in advance. (The number in a parenthesis means the time when each signal was detected). The contact pattern which the touch panel 81 detects is compared with the patterns registered in the table, and if there is a registered pattern which matches the contact pattern, the operation of the program paired with the registered pattern can be executed. Although this is an example which realizes mapping relation with a definition table, the pattern registered is defined using the touch-panel-input-assisting-device. (As a result, the registered pattern is dependent on the characteristic of the touch-panel-input-assisting-device.) Since such parameters as α, β, γ, and S and the registered patterns are determined so that the finger movement, the reaction force and the operation of the program are synchronized with a proper amount and a proper timing, they are called the data for synchronization. The data for synchronization is memorized in the procedure of computation or in the memory of a computer in advance and, by using them, the tactile sense interlocking program can acquire the key for a synchronization from the contact pattern itself without additional signal for synchronization, and it can synchronize the operation of the program with the finger movement or the tactile feeling of the finger.

FIG. 11 shows the features of the synchronous method of this invention that synchronizes the reaction force which the finger feels (reaction force which a reaction-force-generation-means applies to a finger when the touch-panel-input-assisting-device is operated with a finger) with the operation of a computer or a program using the data for synchronization. For comparison, the conventional synchronous method using the signal for synchronization is also shown. Among the various above-mentioned mapping systems, as an example, the case where mapping relation is defined by the easiest formula is illustrated for simplicity. As for the case where mapping relation is defined by a procedure, the map in the figure can be defined by the procedure, and the data for synchronization can be represented by the parameters and the registered patterns which are used in the procedure.

FIG. 11 shows an example of the computer operation method or the tactile sense interlocking program of this invention in (a), and an example by conventional method in (b). In both of the examples, the touch-panel-input-assisting-device is provided as a peripheral device out of the computer. And independently from the touch-panel-input-assisting-device, the computer operating method or the tactile sense interlocking program of this invention is implemented in the computer. Moreover, the touch panel is separate from the touch-panel-input-assisting-device and the contact pattern generated by the touch-panel-input-assisting-device inputs into the computer through the touch panel. Although the information exchanged between the touch-panel-input-assisting-device and the computer is only the contact pattern in (a), the signal for synchronization also needs to be exchanged besides the contact pattern in (b). The most important feature of (a) is that, by memorizing the various characteristics (such as the range of values of the contact pattern for the proper movement range of a finger or the value of the contact pattern for reaction force of a predetermined strength) of the touch-panel-input-assisting-device in the memory in the computer or to the parameters of the procedure as data for synchronization in advance before computer operation, it can estimate the timing of the finger movement performed and the timing of the reaction force generated only from the information on the contact pattern, without signal for synchronization, and operate the computer synchronizing with the timings.

The map in FIG. 11(a) is defined by the formula of ΔZ=αΔX, where ΔX is the amount of displacement of the contact point on the touch panel given by the input operation to the computer, and ΔZ is the amount of movement of an object on a screen of a video game. When playing a game, there is a proper range for the finger movement to control the game and the reaction force should be applied to the finger within a proper range of strength. In order to move the object on the screen of the video game with a proper amount by the operation within those proper ranges, the value of α must be determined appropriately. And for this purpose, the characteristic of the touch-panel-input-assisting-device must be investigated in advance, and it must be recorded in the memory as data for synchronization. This characteristic includes the range of values of the contact pattern generated by the touch-panel-input-assisting-device when it is manipulated under a proper range of finger movement, or a proper range of reaction force. Since the operation of the program can be controlled only from the contact pattern without any signal for synchronization by using the value of the a in the computer side, α is called the data for synchronization.

When operating the touch-panel-input-assisting-device of FIG. 3 with a finger, the range of finger movement for a proper range of strength of reaction force or the range within which a finger can move comfortably is constrained inside the ellipse of the dashed line of 206 in FIG. 12. Moreover, the ellipse of the dashed line of 207 shows the range within which the contact point of the rolling unit 31 on a touch panel moves for the movement range of the finger. The range of 207 is determined by the characteristic of the touch-panel-input-assisting-device, and it becomes the range of half the movement range of a finger in this example. The value of α must be determined so that, according to the amount of displacement of the contact point generated within this range, the object on the screen can move with a proper amount. The touch-panel-input-assisting-device of FIG. 12 differs a little from what was shown in FIG. 3. In the example of FIG. 3, the touch-panel-input-assisting-device is equipped to the finger using a band 42 tied around the finger and fastened with the buckle 43, while in the example of FIG. 12, the touch-panel-input-assisting-device is equipped to the finger using a band that is fastened by the restoration force generated by the thick rubber part 205 which pulls the band when it restores to a straight state.

In this invention, the panel equipped with the contact-position-detection-means is generically named the touch panel regardless of the kind of the detection means. When a contact-position-detection-means is a pressure-sensitive type like a resistive film sensor, the contact area of a rolling unit on a touch panel needs to be small and localized so that a proper amount of pressure can be applied. On the other hand, when a contact-position-detection-means is an capacitive sensor, the rolling unit or the film which is interposed between a rolling unit and a touch panel needs to be made of the material with proper conductivity or dielectric constant, and a part of it needs to be in contact with the human body or the reference electrode of the sensor. Furthermore, when a contact-position-detection-means is an optical sensor, the rolling unit surface needs to be equipped with a marker to be identified, or it is necessary to consist of materials which may reflect the modulated light which is emitted from a light source.

Alternatively, a touch panel is comprised of the electrodes arranged in the form of a matrix so that a pressured position may be detected by the contact relation between electrodes, and the contact position at which the rolling unit rolling on the panel surface contacts directly or indirectly to the panel is detected. When contacting directly, the lower part of the rolling unit contacts directly to the surface of a touch panel, however, when contacting indirectly, it presses in-between sheet or belt which were made of the flexible material like rubber or cloth, and the sheet or belt pressed by the rolling unit contacts the touch panel 2. For example, in the example of composition of FIG. 2, the silicone rubber sheet 50 is stretched over the touch panel 2 with a proper gap separating it from the surface of the touch panel 2. The silicone rubber sheet is deformed at the position where it is pressed by the rolling unit and contacts the touch panel. As the rolling unit rolls pushed by the finger, the sheet is pressed at different positions and the coordinates of the contact positions (51, 52) inputs.

The sectional view which cuts a ball-like rolling unit 31 perpendicularly is shown in FIG. 2. A cylindrical hole is formed at the bottom of the ball-like rolling unit 31, and a spring 44 is placed in it. The upper end of the spring is attached to the upper part of the cylindrical hole with a metal connector 45. Moreover, the lower end of the spring is attached to a silicone rubber sheet 50 through the joint component 41. Using a support component 53 as a spacer, the silicone rubber sheet 50 is stretched over the touch panel 2 separated with a proper gap from the panel surface. If the upper part of the ball-like rolling unit 31 is pushed down with a finger, the silicone rubber sheet is deformed as shown in (b), and the ball-like rolling unit lower part sandwiches a silicone rubber sheet and the joint component 41 in-between, and contacts the touch panel 2 at the position of 51. Moreover, when the finger moves leftward on the figure, pushing the ball-like rolling unit 31 against the touch panel 2 with a finger as shown in (c), with the spring 44 being extended, the ball-like rolling unit 31 rolls towards the left, and contacts the touch-panel surface in the position of 52 through the silicone rubber sheet which is pushed and deformed. Meanwhile, the spring 44 tries to restore itself to the original length and the reaction force F1 is applied to a finger to the direction indicated by an arrow in the figure, and thus this mechanism explained above serves as a reaction-force-generation-means. The strength of this reaction force can be computed based on the contact position 52 on a touch panel. In addition, an elastic silicone rubber 77 can be used instead of the spring 44 as shown in FIG. 5 and it can be molded as a single piece with the sheet 50 which is also made from silicone rubber. As shown in (c), the tip part 78 which is thinner than the main part 77 can be pulled upward after letting it pass in the hole of the ball-like rolling unit 31 made from silicone rubber. By pulling 78 upward, a swelled portion 76 of 77 can be drawn into the cavernous part 75 inside the ball-like rolling unit 31, jointing 77 and 31 as shown in (d), cutting 78 with the dashed line 79 of (d) after that, and the structure shown in (a) is producible simply and at a low cost.

The length of the spring 44 is secured by connecting it to the bottom of the concavity of a rolling unit, letting the stress added to the material distributed when making the rolling unit operate and roll. Moreover, if the material of the rubber sheet 50 or the rolling unit 31 is made from conductive rubber, the rolling movement of the rolling unit is detectable with a capacitive type touch panel. If they are made from conductive materials such as conductive rubber in other embodiments of the invention hereinafter, the contact pattern is also detectable with a capacitive type touch panel.

The touch-panel-input-assisting-device 80 by this invention contacts a touch panel through a rolling unit. Even when it is equipped to the finger, a rolling unit is connected through a spring or an elastic cord, for example, so that the elasticity of them may draw the rolling unit to a finger and have the flexibility with which the rolling unit can roll on the surface of the finger. The example of composition of such a touch-panel-input-assisting-device 80 is shown in FIG. 3. The ball-like rolling unit 31 has the same structure as FIG. 2 and is attached to a band 42a through the joint component 41 using the same principle as FIG. 2, where the band is tied around the finger. After tied with a buckle 43 and passing through it, although not contained in a figure, the part of the band 42b is further extended, its end leads to the housing of the touch panel 2, connected with it, and functions as a strap which prevents fall and loss of the touch-panel-input-assisting-device 80. The side view which looks at (a) from the thumb tip side is shown in (b).

The section of the ball-like rolling unit of FIG. 3 and the principle of rolling operation are shown in FIG. 4. The side view seen from the tip side of the thumb is shown in (a). It shows the section when the ball-like rolling unit 31 is divided perpendicularly where 42c is the band tied around the thumb, and the end of the spring 44 is attached to this band through the joint component 41. This spring passes through the cylindrical hole which was made inside the ball-like rolling unit 31, and its end is joined to the bottom of the hole by the metal connector 45. The side view seen from the transverse direction of the thumb is shown in (b) where 46 is the position where the rolling unit 31 touches the panel 2 before rolling operation. The scene of moving the finger horizontally toward the transverse direction and making the ball-like rolling unit roll is shown in (c) and the scene of moving the finger backward and making the ball-like rolling unit roll is shown in (d). In any case, the ball-like rolling unit rolls along with a motion of the finger, and the contact position moves to 47. Meanwhile, the spring 44 is extended and the reaction force which draws a finger back to the direction F1 is generated when the spring shrinks and is restored. This will function as a reaction-force-generation-means.

The touch-panel-input-assisting-device 80 in FIG. 7 generates the reaction force according to the amount of deformation of the rolling unit 31 when the rolling unit is struck or crushed. For example, if the side of the rolling unit 31 in contact with the touch panel 2 is formed in the shape of a curved surface with a material with flexibility and elasticity, such as silicone rubber, and pressed against the touch panel 2 by giving pressure on the rolling unit 31, the above-mentioned curved surface will be crushed and will contact the touch panel 2 in a large area while giving reaction force to a finger. The amount of deformation of the rolling unit, the strength of the pressure given to the rolling unit and the strength of the reaction force given to the finger can be computed from the size of the contact area on the touch panel 2. It is also possible to compute the reaction force given to a finger by preparing pressure sensors, such as a piezoelectric device and detecting the pressure added to the touch panel 2. The contact area size of the rolling unit 31 on the touch panel 2 is detectable through the resistance or the electric capacity value which the sensor on the side of the touch panel 2 detects, or through the number of electrodes which contacts each other electrically. The touch-panel-input-assisting-device 80 based on such a principle is shown in FIG. 7. A circular section 55 shows a section of the ball-like rolling unit 31 mentioned above. If the rolling unit is formed with the material such as a hollow rubber, which is easily deformed, in any case, the contact area size of the rolling unit 31 on the panel 2 at the contact position 56 is small in the case of being pushed against the panel 2 by a weak force as shown in (a), and large in the case of the crushed and deformed rolling unit being pushed against the panel 2 by a strong force as shown in (b) for the contact position 57. Meanwhile, in (b), the crushed rolling unit 31 tends to be restored to the original form, and generates the reaction force F2. The strength of this reaction force can be computed from the size of the contact area of 57 by measuring it by a certain method.

For example, in the case of the resistive type touch panel sensor, when contacting the touch panel 2 by two points simultaneously, the position (center-of-gravity position), which is the average over the contact positions with the weight of the contact area size, is detected as a contact position. For example, in FIG. 7, P and Q are detected as the center-of-gravity position. When the size of the contact area changes according to the degree of deformation of the rolling unit, the center-of-gravity position of the two points changes according to the degree of deformation. Therefore, the degree of deformation can be detected from the center-of-gravity position which the touch panel detects.

In the touch-panel-input-assisting-device 80 described so far, in any case, the rolling unit rolls, changing the contact position on the finger surface as well as the contact position on the panel surface, being sandwiched between the two surfaces, if a finger moves pushing a rolling unit against the touch panel 2. The amount of rotation of the rolling unit can be computed from the contact position detected by the touch panel. During this operation, the spring or the elastic cord connecting the rolling unit are extended and the reaction force is generated when it is restored to the original length. Since the strength of this reaction force is computable through the amount of movement (the amount of change) of the contact position while the rolling unit rolls keeping in touch with the touch panel, the program can be controlled to synchronize with the reaction force. Although the reaction force can also be computed directly by detecting the tension of the string which pulls a rolling unit using a force sensor or a distortion sensor, etc. instead of computing the reaction force indirectly from the amount of movement of the contact position, it is desirable to compute the reaction force through the amount of movements of contact position as it is detectable on the side of the touch panel.

In the tactile sense interlocking program of this invention, by associating (relating or mapping) the reaction force computed as mentioned above with a variable in the program, it becomes possible to grasp the contents of operation through the reaction force, or the presence of a game can be improved. That is, when an operator rolls a rolling unit, he can grasp the value of the variable through the strength of the reaction force which a finger feels, and the direction of a vector in the program through the direction of reaction force. It is also possible to associate the direction angle of the reaction force with the value of a variable if the direction is represented by an angle instead of a vector. For example, in a video game of shooting a target, the strength of the reaction force can be associated with the strength of power with which a ball is shot and the direction of the reaction force can be associated with the direction to which a ball is shot. With these associations, the force which a finger feels and the force applied to the object in a game are intuitively related, and the presence of the shooting game is improved. In the games such as ‘Pachinko’ (Japanese pinball machine) for which the feeling of the reaction force felt when pulling or releasing an elastic string or the feeling of bouncing force when pushing an object is important, the reaction force which the touch-panel-input-assisting-device 80 of this invention generates can imitate those forces and improve the reality or presence of the games.

The tactile sense interlocking program is a program used in combination with the touch-panel-input-assisting-device and executes a predetermined operation synchronizing with one of the following events, the rolling unit separates from the panel, the contact position of the rolling unit and the panel moves for a predetermined distance or arrives at a predetermined position, and the moving pattern or the speed pattern of the contact position matches a predetermined pattern. Since the position or the speed of the contact point generated by the contact-pattern-generation-means is limited within a certain range (between the lower and the upper bounds), it is necessary to define the mapping relation between the generated pattern and the predetermined operation so that the operation can be performed within the value of the limited range. (Namely, it is required to taking into consideration the characteristic of the touch-panel-input-assisting-device.)

The tactile sense interlocking program is a program which detects the finger movement which is converted to the rolling movement of the rolling unit on the touch panel by the touch-panel-input-assisting-device, based on the movement of the contact point of the rolling unit on the touch panel and the change of the movement speed. This program also presumes the concrete form of the finger movement if needed, and executes a predetermined operation synchronizing with movement of the finger. For example, when detecting a finger movement vertical to the touch panel, if the movement of the contact position of a rolling unit and a touch panel stops after exceeding the speed of a certain predetermined size, and then reverses a direction, the program can judge that the finger contacted the touch panel after it approached the touch panel, and stood still on the touch panel, and then separated from the touch panel. And if the program is made to perform a predetermined operation at the time of the contact position movement stopped or at the time of the moving direction reversed, the movement of the finger and operation of the program can be synchronized at these timings. Or more simply, a predetermined operation can be performed synchronizing with the time of: contact having been completed, the contact position arriving at a predetermined position, the movement speed reaching a predetermined speed, or the amount of relative movements becoming predetermined amount. Or more generally, the program can perform a predetermined operation synchronizing with the time of the moving pattern (the pattern of movement or speed) of the contact position matching with the predetermined movement pattern registered in advance. If the reaction force which a rolling unit returns to a finger changes according to the amount of roll, the amount of reaction force can be estimated by measuring the amount of movement of the contact position while the rolling unit and the touch panel has maintained the contact state. So the program is designed to perform operation according to the size of the reaction force synchronizing with the time of the rolling unit separating from the touch panel. When the surface of the rolling unit is uneven or having some corners, the contact position of the rolling unit surface and a panel changes discontinuously when a rolling unit is made to roll. So, when a discontinuous change is detected through a touch panel, it judges that the movement of the finger with which a specific position on the surface of a rolling unit contacts the touch panel and rolls on it was performed, and the program is made to perform a predetermined operation.

For example, the scene of the game in which a ball 61 is hit with a bat 60 is shown in FIG. 8. If the correspondences are taken between the angle of the bat, the amount of swinging the bat 62, or the power of hitting the ball and the amount of roll of the rolling unit or the strength of reaction force of the touch-panel-input-assisting-device 80, the player of a game can grasp the angle of pulling the bat or the strength of power to hit the ball through the reaction force given to the finger. That is, since the power in a virtual game can be grasped by actual power, the presence of the game increases. Moreover, even if the player does not gaze at the angle of the bat in a screen, the angle of the bat and the strength of power to hit the ball can be tactually grasped. As for reference numeral 63 showing the locus of a ball, the speed of the ball or the power of the bat with which the ball rebounds can be determined according to the speed and the power felt when pulling and releasing a rolling unit. Moreover, whether a ball and a bat collide can be determined based on the strength of the reaction force added to the finger just before releasing a rolling unit and the releasing time. The releasing time and the strength of the reaction force are detectable by the contact state and contact position detecting function of a touch panel. In this case, a suitable mapping relation have to be defined between the variable value which defines the angle of the bat in a program and the reaction force or the contact pattern so that a proper relation can be established between the angle of the bat and the reaction force added to the finger or the amount of finger movement. Therefore, the program must be designed depending on the characteristic of the touch-panel-input-assisting-device.

In another example, the variable in the program is associated with (related to) the amount of deformation or the reaction force when applying pressure and deforming a rolling unit as shown in FIG. 7. For example, if a scene of hitting or crushing an object etc. is contained in the contents of a play of a game such as a boxing game or Whack-A-Mole game, the amount of deformation or reaction force when a rolling unit is pressed or crushed is detected, and it is related with the value of the variable which defines the damage given to the opponent or the mole, with this association, the contents of the game and the operation given to the rolling unit are intuitively related, and the presence of a game is improved. It is necessary to give suitable mapping relation between the amount of deformation, the strength of reaction force, and the variable values specifying such damage in the program. Therefore a program must be designed depending on the characteristic of the touch-panel-input-assisting-device.

The touch-panel-input-assisting-device of this invention is equipped on the panel with the contact-position-detection-means, attached to a finger or held with a finger, and is equipped with the rolling unit which contacts the panel directly or indirectly, and rolls on it, and it has a movement-conversion-means to convert the movement of a finger which approaches the panel surface from the direction approximately perpendicular to the panel surface into the rolling movement of the rolling unit while the rolling unit is contacting the panel. And the contact-pattern-generation-means is realized by generating a contact pattern by the roll of the rolling unit, and the reaction-force-generation-means is realized by giving a resistance force or reaction force to a finger moving close to the panel surface via the rolling unit rolling on the panel.

Although the conventional touch panel detects movement of a finger or a stylus parallel to a touch panel surface, the touch-panel-input-assisting-device makes it possible to detect the finger movement approaching the touch panel surface from the perpendicular or a slanting direction. For that purpose, the rolling unit converts movement of a finger into its own rolling movement on a touch panel, and movement of a finger that approaches the panel is detected as movement of the contact position of the rolling unit and the touch panel. Contacting indirectly means contacting via interposing film, cloth, etc. which is deformed easily between a rolling unit and a panel. Moreover, the rolling unit is any object that rolls or inclines, changing the position of the contact point on a panel regardless of its shape, so the form of the rolling unit is necessarily neither a sphere nor a wheel form. For example, it can be simply an object which inclines like a seesaw. It will be called a rolling unit as far as the position of the contact point on a panel moves when it inclines. If the contact surface on which the contact occurs between the rolling unit and the panel is curved, the contact position would move continuously when the unit inclines. If the contact surface has angles, such as a gear, the contact position would move discontinuously, but it is still called a rolling unit as far as the contact position with a panel moves when it rolls or inclines. Since the contact position moves discontinuously by a predetermined skip distance, especially when making a surface with an angle roll, the input by such a rolling unit is distinguished from that of a usual stylus etc.

The touch-panel-input-assisting-device 80 of FIG. 6 can convert the movement of a finger approaching a touch panel into a rolling movement of the rolling unit continuously contacting the touch panel surface. An example of a single piece prototype of the touch-panel-input-assisting-device 80 made by integral molding with rubber is shown in (d), (e), and (f) of FIG. 6. This single piece version operates by the same principle as another prototype of the touch-panel-input-assisting-device shown in (a), (b), and (c) of FIG. 6. The figure in (d) shows the top view, the upper part 32 of the device crawls on the upper surface of a finger (a dashed line shows), and the side part 34 of it is used to hold the device by applying the thumb on it. Figures in (e) and (f) shows the side view, and they show how the rolling unit 33 rolls on the touch-panel 2 when a finger moves close to a touch panel. The scene of (e) shows the rolling unit 33 contacting the touch panel 2 at the position of 36. When the finger is brought further close to a touch panel, the rolling unit 33 rolls on the touch panel 2 and the contact position moves to the position 37 as shown in (f). As the whole device is made as a single rubber piece, the device must bend between the rolling unit (rolling part) 33 and the upper part 32 when the rolling unit 33 rolls. In addition, the adjunct part 101, which is introduced in order to give reaction force and tactile feeling to a finger, bends to generate a restoration force and, by touching the undersurface of a finger, the feeling of contact. The lubricant coating technique Teflon (registered trademark) can be applied to the surface of the rolling unit 33 in contact with the touch panel 2 to make it slide smoothly on a touch panel surface.

Another prototype of the touch-panel-input-assisting-device of this invention is shown in FIG. 10. This touch-panel-input-assisting-device is made by integral molding as a single piece of a rubber or conductive rubber material. The part 33 of it operates as the rolling unit (contact-pattern-generation-means), the holding part (holding means) 39 is where it is held by fingers, the adjunct part 101 gives tactile feeling when it contacts a finger and is crushed, and the part 102 is the projection to contact the a touch panel. The figures in (a), (b), and (c) show the touch-panel-input-assisting-device seen from different viewpoints. The figures in (d), (e), and (f) show how the rolling unit 33 rolls and the contact position moves starting from P1, moving to P2 and P3 on the touch panel surface when the fingers apply a force (F) from the direction approximately perpendicular to the touch panel surface and approach the touch panel. The rubber material constituting the device is deformed and gives a reaction force to a finger when it tries to restore its original shape due to its elasticity, and this can be the reaction-force-generation-means. Moreover, the projection part 102 would contact a touch panel and the contact pattern will change suddenly if the finger holding the holding means 39 moves very close to the touch panel and the rolling unit rolls on the touch panel as shown in (f). The program can detect this sudden change in the contact pattern and judge that the finger moved to the specified position.

The flow chart of the tactile sense interlocking program is shown in FIG. 9. The contact-pattern-generation-means of the touch-panel-input-assisting-device of this invention converts various finger movements into rolling movements of the rolling unit on the touch panel. The pattern of movement or speed of the contact point between the rolling unit and the touch panel must take a form that is characteristic to each pattern of finger movement. Meanwhile, tactile feedback (tactile feeling) such as a resistance force, reaction force, vibration, or a feeling of unevenness is generated by the reaction-force-generation-means and given to a finger in synchronizing with the specific feature of the contact pattern or the finger movement. With this tactile feedback synchronized with the contact pattern, an operator can control his finger movement with high precision. On the other hand, the tactile sense interlocking program of this invention analyzes the movement pattern or speed pattern of the contact position of a rolling unit and a touch panel to find the characteristic form, estimate the original finger movement, and it performs specific operation in synchronizing with the finger movement or the tactile feedback the finger perceives.

For example, when a rolling unit separates from a touch panel, the contact position of a rolling unit and a panel moves for a specific distance or arrives at a specified position, the movement or speed pattern of the contact position takes a specific pattern, the contact position suddenly stops, or the contact position suddenly reverses its moving direction, the operation specific to each event is performed, synchronizing with the event. The flow chart of FIG. 9 shows an easy and concrete example to explain the procedure for the synchronization mentioned above. Each variable in the program is initialized first and the procedure is started. Chattering process is performed to the signal about the contact state of a touch panel during the procedures, and short-time disconnection is ignored and dealt as a continuous contact.

After performing the chattering process, in Step 1, it is detected whether the rolling unit touches the touch panel. When the rolling unit touches the touch panel and it turns out that it is not in contact at the last time by Step 4, since it means it contacts for the first time, it is judged as the contact to have started, the time of a timer is reset to 0, and the information on a contact position and time is recorded by Step 5. And monitor of the contact state and coordinates of the contact position is continued. Moreover, if it is in contact at the last time, it considers that the contact has been continuing and the speed and average speed of the contact position is computed in Step 6.

And in Step 7, it is evaluated whether, the contact position of a rolling unit and a touch panel arrived at the specific position, or moved for a specific distance, or its speed exceeded a specific threshold, or the contact position stopped after exceeding the speed of a certain size, or its moving direction was reversed. And if either of these conditions or a combination of some of them is satisfied, in Step 8, a predetermined operation is performed according to those conditions. The value of variable used in the operation is defined according to the average speed, the maximum speed, or the amount of movement of the contact position. Various finger movements can be estimated from the movement pattern of the contact position. For example, if the contact position stopped after moving with the speed exceeding a threshold and then started to move to the opposite direction, it is estimated that the finger approached the touch panel, contacted its surface, stood still on the touch panel, and separated from it. Although various kinds of “predetermined or specific” value has been used in the above explanation, such predetermined or specific value is a part of the data for synchronization and should be determined depending on the characteristic of the touch-panel-input-assisting-device. These values should be memorized in the memory of a computer or embedded in the procedure of the program in advance, and used in the tactile sense interlocking program in order to take the synchronization between the finger movement or the tactile feeling the finger perceives and the program.

Thus, the movement of a finger or the reaction force given to a finger is estimated from the moving pattern or the speed pattern of the contact position, and a predetermined operation is performed in a predetermined quantity according to it. If it is detected in Step 21 that the rolling unit touched the touch panel at the last time, but it is not in contact at present, then it is judged that the rolling unit separated from the panel. Then, the position at the time of separation is recorded in Step 22, and also the sound is stopped in Step 24. This is going to imitate the real piano in which the sound continues while pushing a key, but the sound declines immediately if a finger is lifted from the key. Finally in Step 25, after resetting all the variables, it returns to Step 1 and the same procedure is repeated.

(Correspondence Between the Name of Each Means in the Claim, and the Component of Each Figure of an Enforcement Form)
The rolling unit 31 of FIG. 2 is equivalent to the contact-pattern-generation-means.
The silicone rubber sheet 50 and the support component 53 of FIG. 2 are equivalent to the wearing means.
The metal connector 45, the spring 44, the joint component 41, and the silicone rubber sheet 50 of FIG. 2 are equivalent to a reaction-force-generation-means.
The rolling unit 31 of FIG. 3 and FIG. 4 is equivalent to a contact-pattern-generation-means.
The bands 42a, 42b, and 42c to tie around the finger and the buckle 43 of FIG. 3 and FIG. 4 are equivalent to the wearing means.
The bands 42a and 42c to tie around a finger, the joint component 41, the spring 44, and the metal connector 45 of FIG. 3 and FIG. 4 are equivalent to the reaction-force-generation-means.
The rolling unit 31 of FIG. 5 is equivalent to the contact-pattern-generation-means.
The silicone rubber sheet 50 of FIG. 5 is equivalent to the wearing means.
The silicone rubber cord 77 and the silicone rubber sheet 50 of FIG. 5 are equivalent to the reaction-force-generation-means.
The rolling unit 33 of FIG. 6 is equivalent to the contact-pattern-generation-means.
The upper part 32 and the side part 34 of FIG. 6 are equivalent to the wearing means.
The axis of rotation 35, the upper part 32, and the adjunct part 101 of FIG. 6 are equivalent to the reaction-force-generation-means.
The rolling unit 33 and the projection part 102 of FIG. 10 are equivalent to the contact-pattern-generation-means.
The reference numeral 39 of FIG. 10 is the holding means. The adjunct part 101 of FIG. 10, the rolling unit 33, and the holding means 34 of FIG. 6 are equivalent to the reaction-force-generation-means.

### BRIEF DESCRIPTION OF THE DRAWINGS

FIG. 1 is a functional block diagram of a touch-panel-input-assisting-device and a computer system using a tactile sense interlocking program by the form of implementation of this invention.

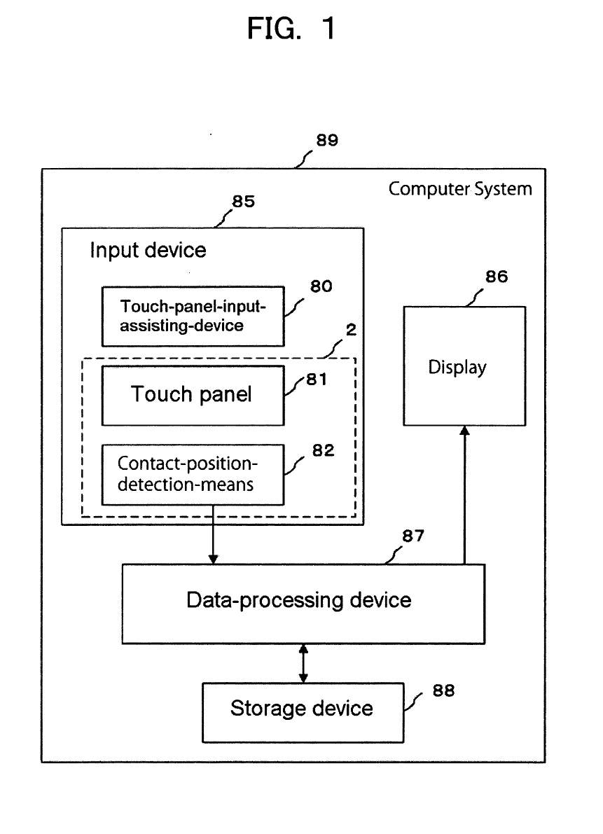

FIG. 2 is a side sectional view showing a touch-panel-input-assisting-device. The spherical rolling unit can be rolled symmetrically by the same strength of the force to any direction of front and rear, right and left. The reaction force is also generated to be isotropic. This isotropic nature is realized by using only one spring which draws the spherical rolling unit to the elastic sheet stretched over the touch panel. (a) shows the neutral state, (b) shows the scene of the rolling unit pushed downward with the finger, and (c) shows the scene of the rolling unit rolled.

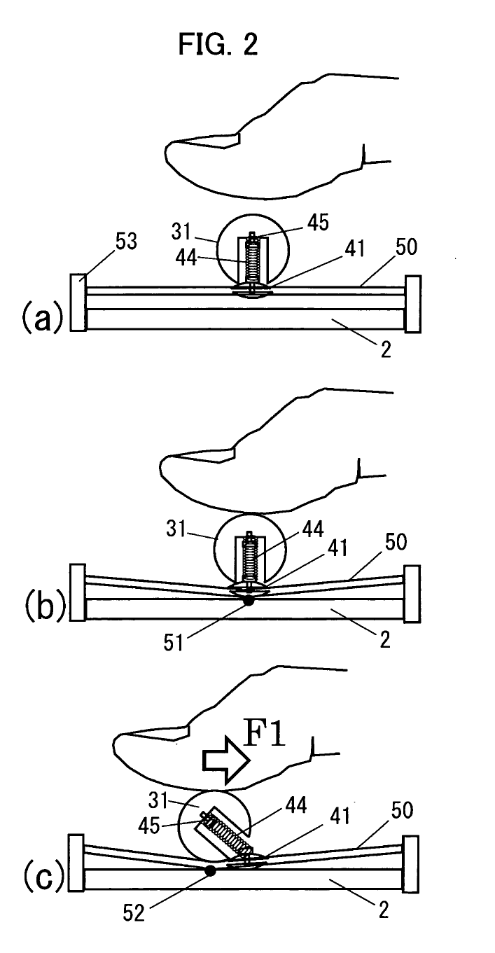

FIG. 3 is a figure showing the type worn by a finger among the touch-panel-input-assisting-device by the form of implementation of this invention. (a) is the side view and (b) is the view looked at from the front of a finger. The touch-panel-input-assisting-device is equipped with the band.

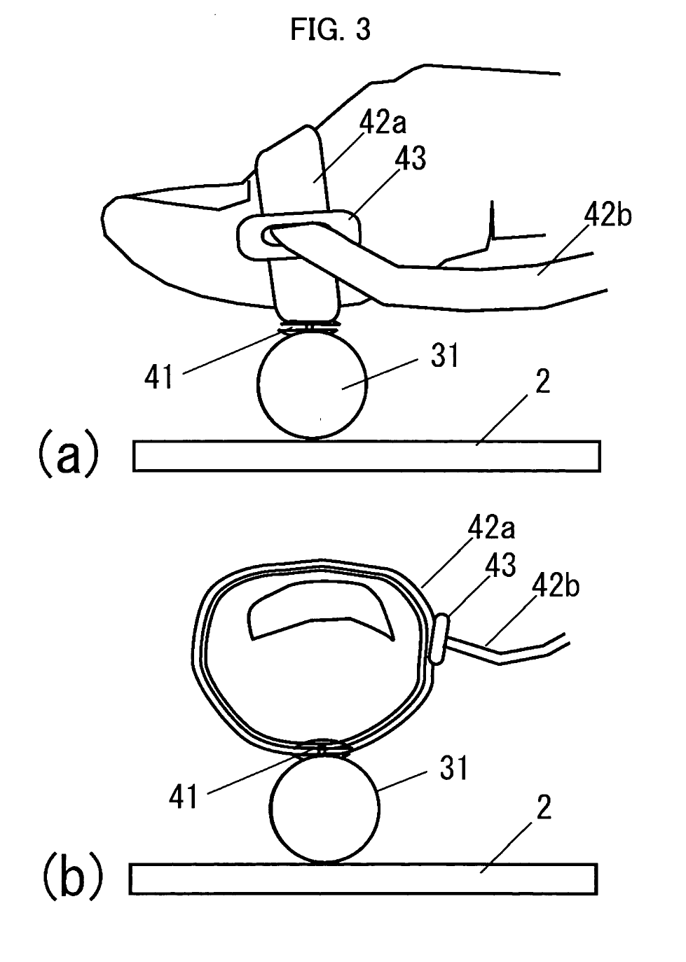

FIG. 4 is a figure showing the scenes that the rolling unit of the finger wearing type shown in FIG. 3 is made to roll on the touch panel. (a) shows the scene of the rolling unit contacting the touch panel before rolling, (b) shows the side view corresponding to (a), (c) is the view from the front of a finger when the rolling unit rolls on the touch pane. (d) shows the side view of the rolling unit when it is made to roll in another direction.

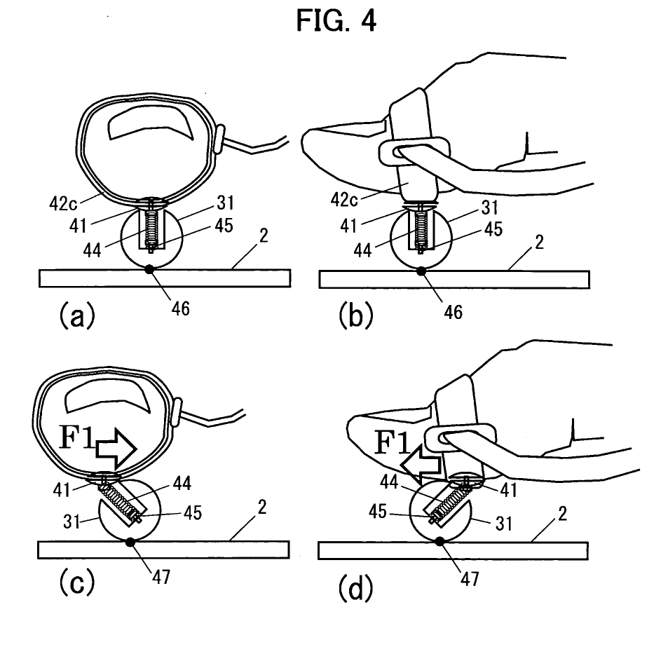

FIG. 5 is a figure showing how to produce the touch-panel-input-assisting-device shown in FIG. 2 at a low cost using the silicone rubber cord unified with the sheet instead of the spring.

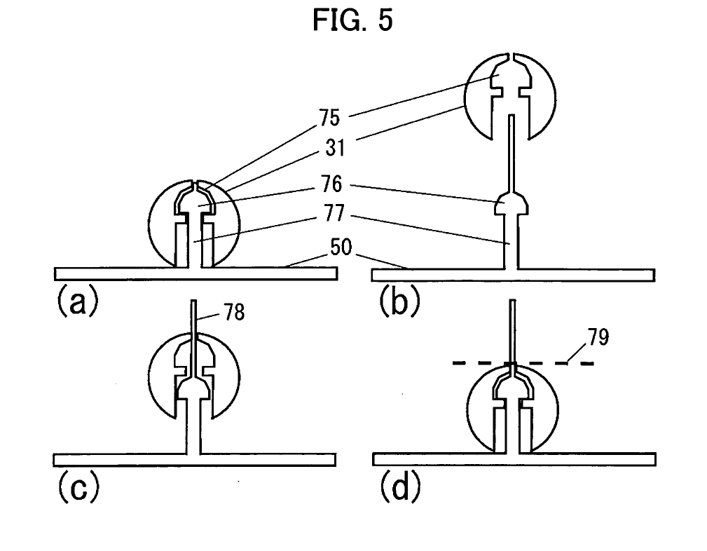

FIG. 6 is a figure showing that the finger movement approaching a touch panel is converted into the rolling movement of a rolling unit. The touch-panel-input-assisting-device of the finger equipped (holding) type is shown. The contact position moves as the rolling unit rolls. The scene of the rolling unit contacting the panel, the scene of the finger approaching the panel moderately, and the scene of the finger approaching the panel to the limit and obtained a feeling of a collision, are shown in (a), (b) and (c) respectively. The single piece version of the touch-panel-input-assisting-device is shown in (d), (e) and (f) which operates by the same principle as (a), (b) and (c).

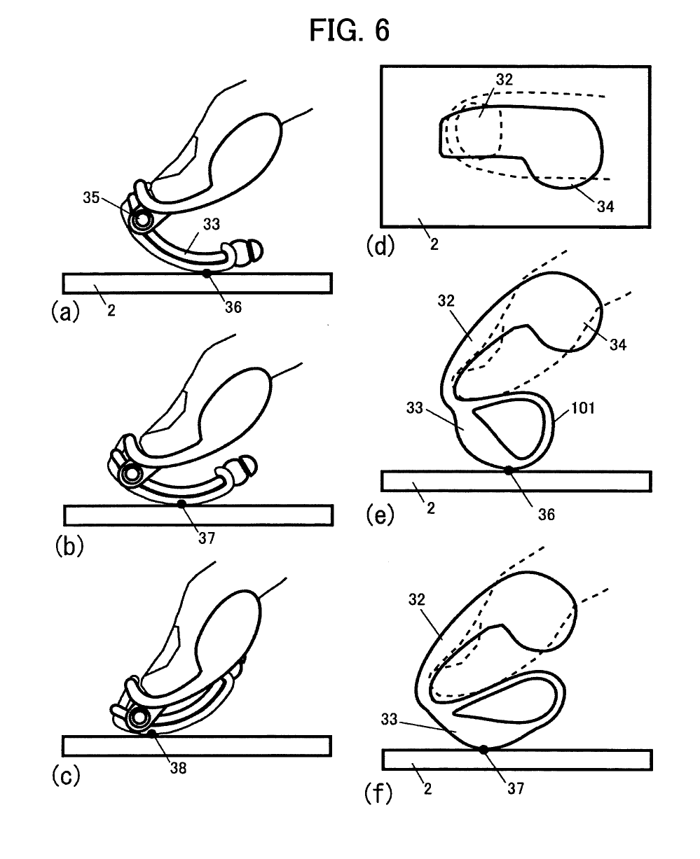

FIG. 7 is a figure showing a means to detect the amount of deformation when pressing and deforming a rolling unit with a finger. The degree of deformation is detected by measuring the size of contact area. (a) shows the original shape and (b) shows the deformed shape.

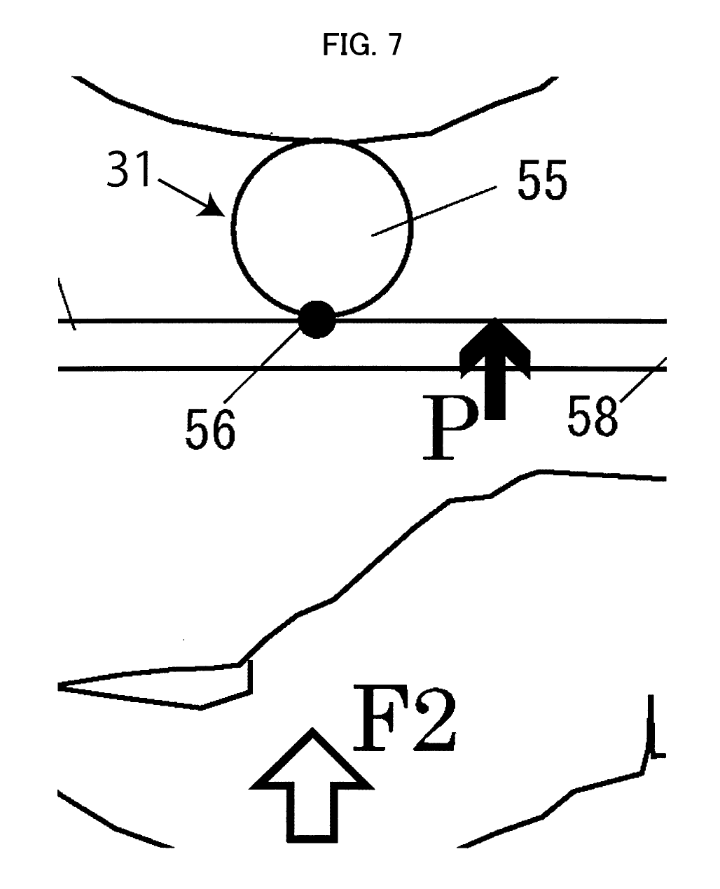

FIG. 8 is a figure showing a scene displayed on the screen in a game in which a bat hits a ball.

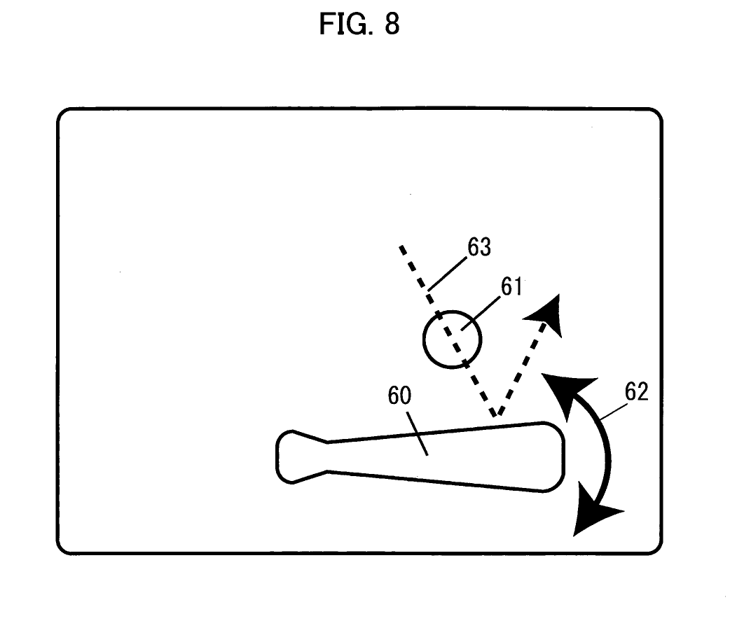

FIG. 9 is a flow chart showing an example of the tactile sense interlocking program.

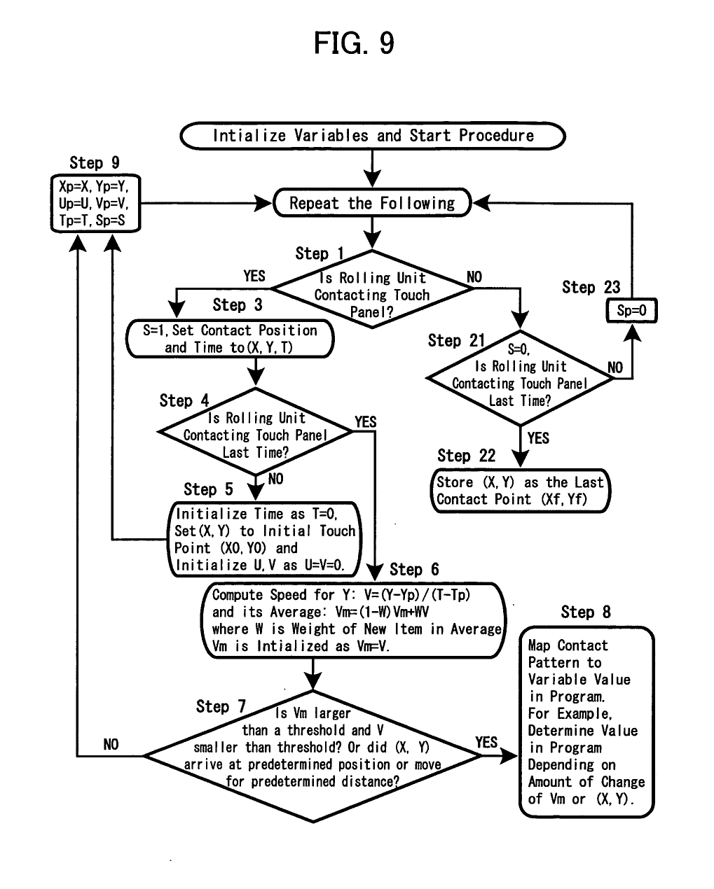

FIG. 10 is a figure showing another example (FIG. 10(a)-(c)) of the touch-panel-input-assisting-device and the diagrams (FIG. 10(d)-(f)) to explain the operation of this invention.

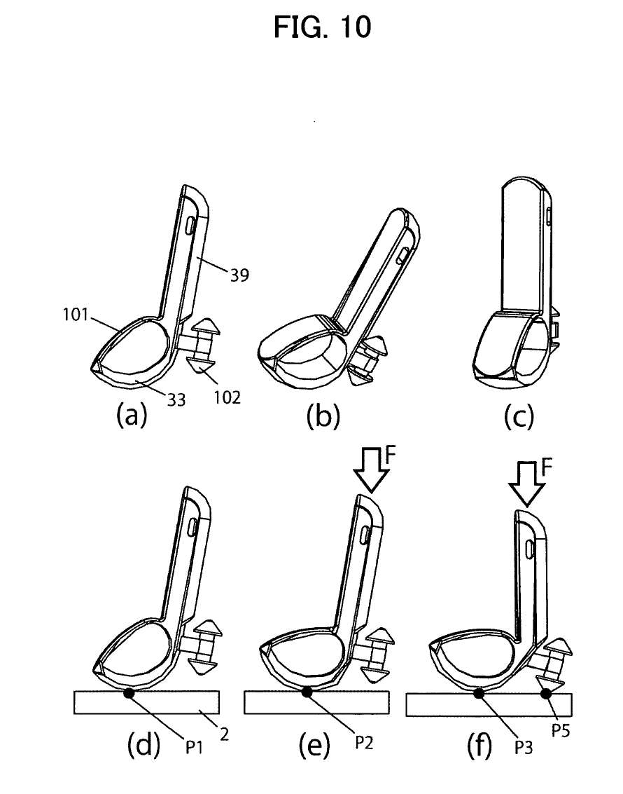

FIG. 11 is a block diagram explaining the feature of the computer operation method or the tactile sense interlocking program of this invention.

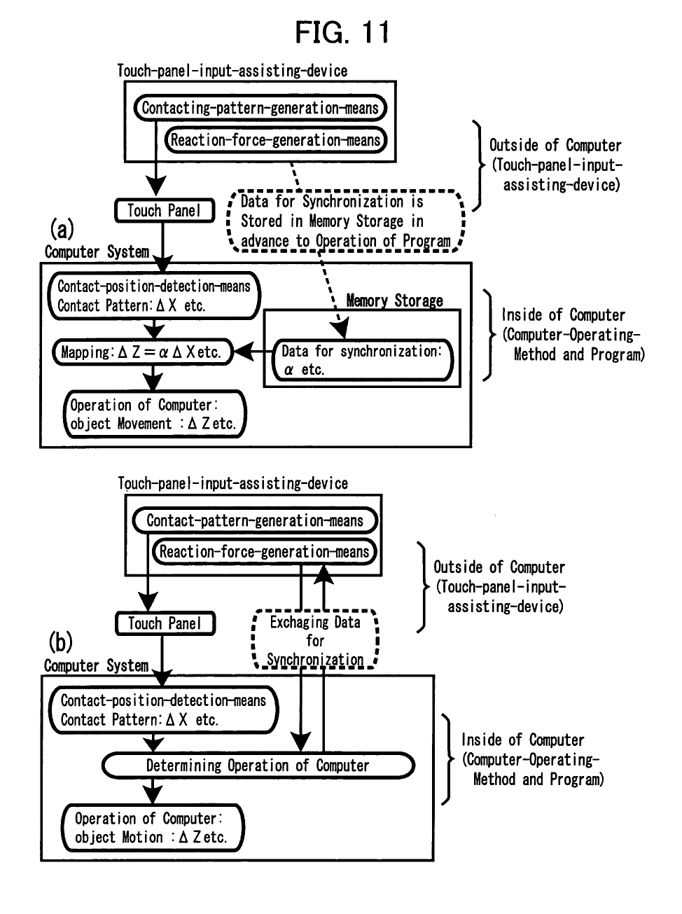

FIG. 12 is a figure explaining the reason for defining the data for synchronization depending on the characteristic of the touch-panel-input-assisting-device.

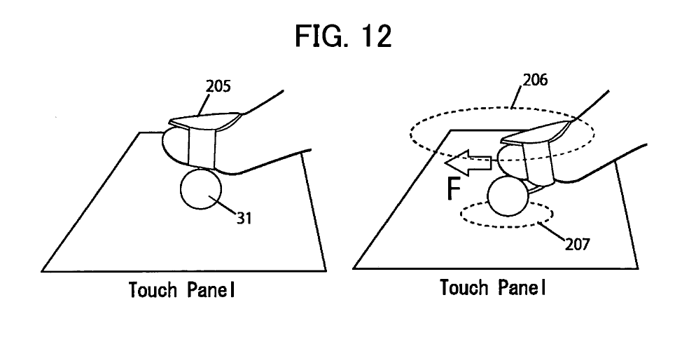

1. A touch panel input assisting device comprising:
a contact-pattern-generation-means interposed between a touch panel equipped with a contact position detection means and a finger operating the touch panel, the contact-pattern-generation-means changing a contact pattern with the touch panel so that the contact pattern is interlocked with a finger movement;
a wearing-means for detachably equipping with the touch panel or the finger, or a holding-means for holding with the finger; and
a reaction-force-generation-means for applying to the finger a reaction force which changes synchronizing with a change of the contact pattern.

2. The touch panel input assisting device according to claim 1,
wherein the contact-pattern-generation-means generates the contact pattern through a rolling unit which rolls on the touch panel according to the finger movement and changes its contact position on the touch panel, and the reaction-force-generation-means generates the reaction force by using a restoration force of an elastic component which is interposed between the rolling unit and the touch panel or the finger.

3. The touch panel input assisting device according to claim 1,
wherein the contact-pattern-generation-means changes the contact pattern with the touch panel so that the contact pattern is interlocked with the finger movement approximately perpendicular to a surface of the touch panel.

4. The touch panel input assisting device according to claim 1,
wherein the contact-pattern-generation-means and the wearing means are made from a conductive and elastic material.

5. The touch panel input assisting device according to any one of claims 1 to 4,
wherein the contact-pattern-generation-means is constituted with a component which slips smoothly on a surface of the touch panel.

6. A computer operating method for synchronizing an operation of a computer with a reaction force which an touch panel input assisting device gives to a finger,
wherein the device comprises a contact-pattern-generation-means interposed between a touch panel equipped with a contact position detection means and a finger operating the touch panel, the contact-pattern-generation-means changing a contact pattern with the touch panel so that the contact pattern is interlocked with a finger movement;
a wearing-means for detachably equipping with the touch panel or the finger, or a holding-means for holding with the finger; and
a reaction-force-generation-means for applying to the finger the reaction force which changes synchronizing with a change of the contact pattern,
wherein the method synchronizes the operation of the computer with the reaction force which the device gives to the finger by using data-for-synchronization which are defined in advance depending on the characteristics of the device and memorized in a storage medium inside the computer and by using a mapping procedure which maps the contact pattern inputted through the touch panel connected to the computer to the operation of the computer.

7. A computer-executable, tactile sense interlocking program for synchronizing an operation of a computer with a reaction force which an touch panel input assisting device gives to a finger,
wherein the device comprises a contact-pattern-generation-means interposed between a touch panel equipped with a contact position detection means and a finger operating the touch panel, the contact-pattern-generation-means changing a contact pattern with the touch panel so that the contact pattern is interlocked with a finger movement;
a wearing-means for detachably equipping with the touch panel or the finger, or a holding-means for holding with the finger; and
a reaction-force-generation-means for applying to the finger the reaction force which changes synchronizing with a change of the contact pattern,
wherein the program synchronizes the operation of the computer with the reaction force which the device gives to the finger by using data-for-synchronization which are defined in advance depending on the characteristics of the device and memorized in a storage medium inside the computer and by using a mapping procedure which maps the contact pattern inputted through the touch panel connected to the computer to the operation of the computer.
